(19) United States
(12) Patent Application Publication
(10) Pub. No.: US 2017/0354098 A1
(43) Pub. Date: Dec. 14, 2017

(54) Plant Training System

(71) Applicant: Dominic J. Paolucci, West Brookfield, MA (US)

(72) Inventor: Dominic J. Paolucci, West Brookfield, MA (US)

(21) Appl. No.: 15/608,456

(22) Filed: May 30, 2017

Related U.S. Application Data
(60) Provisional application No. 62/343,029, filed on May 30, 2016.

(51) Int. Cl. A01G 9/12; F16B 2/08; F16C 11/10

(52) U.S. Cl. CPC A01G 9/124; F16C 11/106; F16B 2/08

(57) ABSTRACT

A plant training system for use with a pot that is arranged to hold a plant includes a plurality of bases that are adapted to be coupled to the pot, wherein each base is adapted to carry a stake or pole, and wherein the angle of the stake or pole relative to the pot is adjustable. There is a mechanical system for holding each base on the pot.

### CROSS-REFERENCE TO RELATED APPLICATION

This application claims benefit of provisional Application 62/343,029 filed on May 30, 2016.

### FIELD

This disclosure relates to a system that supports plants as they grow.

### BACKGROUND

Potted plants can be encouraged to grow more robustly if their branches are properly trained.

### SUMMARY

Featured in this disclosure is a plant training system arranged for potted plants. The system is fully adaptable to the height and diameter of the plant.

All examples and features mentioned below can be combined in any technically possible way.

In one aspect, a plant training system for use with a pot that is arranged to hold a plant includes a plurality of bases that are adapted to be coupled to the pot, wherein each base is adapted to carry a stake or pole, and wherein the angle of the stake or pole relative to the pot is adjustable. There is also a mechanical system for holding each base on the pot.

Embodiments may include one of the following features, or any combination thereof. Each base may comprise a projecting stud that is adapted to be coupled to a stake that has a threaded opening. The stakes can have different lengths. The lengths of the stakes can in one case be adjusted with a stake system in which multiple stakes nest one within another. The bases can comprise a plate that supports a stand that has a number of legs that sit against the outside of the pot.

Embodiments may include one of the following features, or any combination thereof. Each base can comprise a socket that carries a stake, where the sockets are angularly adjustable. The stakes can comprise a ball that is fitted into a socket. Each base may further comprise a mechanism for holding the ball in place in the socket. The mechanism for holding the ball in place in the socket may comprise a screw. The mechanism for holding the ball in place in the socket may further comprise a cup that contacts the ball, wherein the screw is adapted to move the cup relative to the ball. Alternatively, the screw may directly contact the ball.

Embodiments may include one of the following features, or any combination thereof Each base may comprise a pulley, and the mechanical system for holding the bases on the pot may comprise a cord or cable that runs circumferentially around the pot and is coupled to each base via the pulleys. The cord or cable can be tightened in order to hold the bases on the pot. The cord or cable can be tightened using a ratchet-type cable tightening system or a cam jam type cord tightening device.

Embodiments may include one of the following features, or any combination thereof. The plant training system can further comprise twine that is constructed such that it fits over or can be tied to or coupled to a stake. The twine may comprise a pliable metal core with an overcoat of anti-microbial polymer. The polymer may comprise a UV-stabilized thermoplastic rubber.

In another aspect, a plant training system for use with a pot that is arranged to hold a plant includes a plurality of bases that are adapted to be coupled to the pot, wherein each base is adapted to carry a stake or pole, and wherein the angle of the stake or pole relative to the pot is adjustable. Each base comprises a socket that carries a stake, where the sockets are angularly adjustable. The stakes comprise a ball that is fitted into a socket, and a projecting stud that is adapted to be coupled to a stake that has a threaded opening. Each base further comprises a cup that contacts the ball, and a screw that is adapted to move the cup relative to the ball to hold the ball in place in the socket. There may be a number of stakes of different lengths. The plant training system can also include twine that is constructed such that it can be used to couple part of a plant to a stake. The twine can comprise a pliable metal core with an overcoat of anti-microbial UV-stabilized thermoplastic rubber.

### BRIEF DESCRIPTION OF THE DRAWINGS

FIG. 1 is a perspective view of a plant training system in use on a pot that is used to grow a plant.

FIG. 2 is a partial view of aspects of the plant training system of FIG. 1.

FIGS. 3A-3D illustrate another plant training system.

FIG. 4 is a cross-sectional view of an exemplary mechanism that holds an adjustable stake in place.

FIG. 5 illustrates a plant training system in use with a plant.

### DETAILED DESCRIPTION

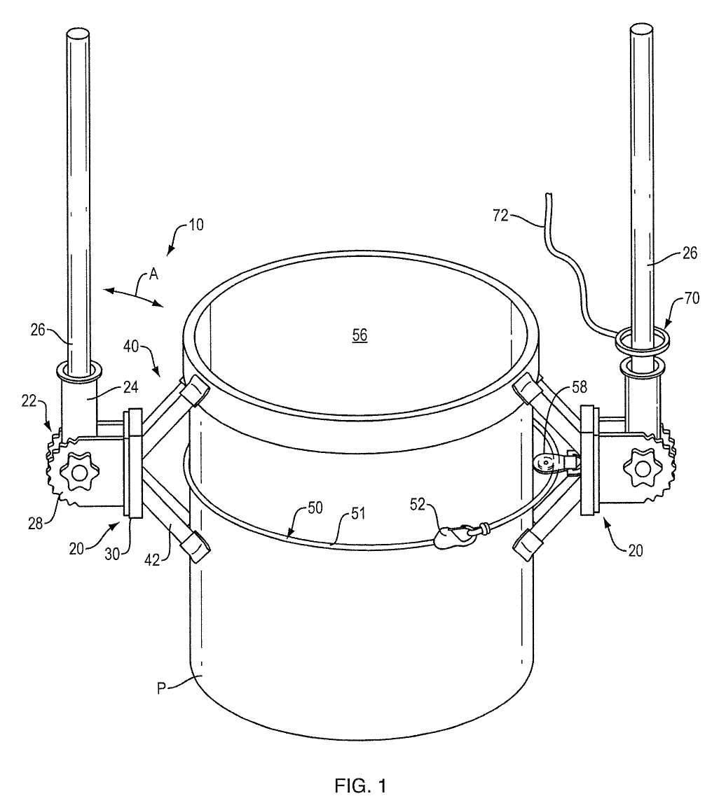

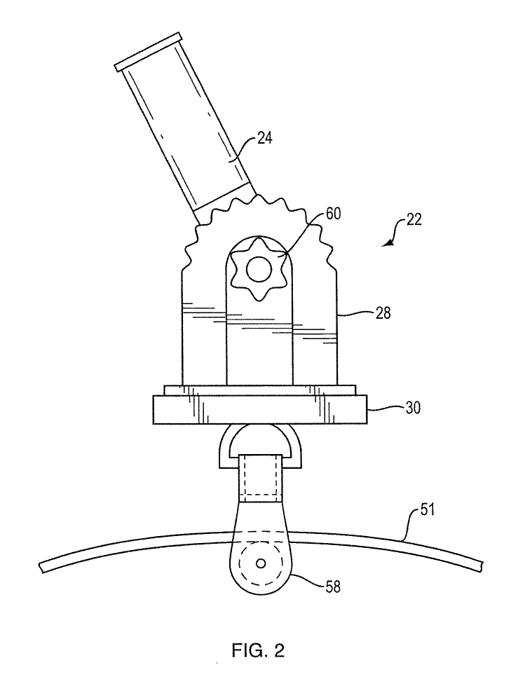

Featured in this disclosure is a plant training system. A first example is plant training system 10, FIGS. 1 and 2. Plant training system 10 has multiple bases 20 that are adapted to be coupled to the outside surface of a pot P in which a plant is to be grown in pot interior region 56. Each base 20 carries a removable/replaceable stake or pole 26. The angle of stake 26 relative to the pot is adjustable, preferably but not necessarily around 360 degrees, as represented by arrow “A.” This allows different plant sizes/heights/diameters to be accommodated. There can be stakes of different length. Or, the height of the stakes can be adjusted with a stake system in which multiple stakes or stake portions nest one within another (e.g., with a tapered interference fit or using a stop).

One example of base 20 is depicted and includes plate 30 that supports a stand 40 that has a number of legs 42 that sit against the outside surface of pot P. Socket 24 carries stake 26. Socket 24 is angularly adjustable using adjusting/locking system 28; this can be accomplished with an adjustable angle flagpole bracket of the type well known in the field and having tightening knob 60. Pulley 58 is coupled to plate 30. The bases can be held onto the pot in any convenient mechanical manner. One non-limiting example is by the use of cord or cable system 50 with cord 51 that runs circumferentially around the pot and is coupled to each base 20 via pulleys 58 (see FIG. 2). The cord can be tightened in order to hold the bases on the pot. Tightening can be accomplished, for example, using a ratchet-type cable tightening system similar to a small come-along (not shown). Tightening can be accomplished in any other manner now known or later developed, including a cam-jam cord tightening device 52.

The stakes provide varied circumferential and varied height and diameter points of attachment for devices (now existing types of devices, or the twine described herein) that can be coupled to branches and the stakes, so as to support the branches, and train the branches to grow in desired directions. One way to couple the stakes to branches is by the use of spool 70 of twine 72. The spools can be constructed such that they slip over a stake and so are held close to the plant. Twine can be used without these spools, though. In one non-limiting example the twine is a pliable metal core with an overcoat (e.g., an extrusion) of anti-microbial polymer, so as to accomplish a bendable but soft twine that is not restricted to particular sizes. The polymer can be an ultraviolet (UV)-stabilized polymer. The polymer can be a UV-stabilized, anti-microbial, thermoplastic rubber.

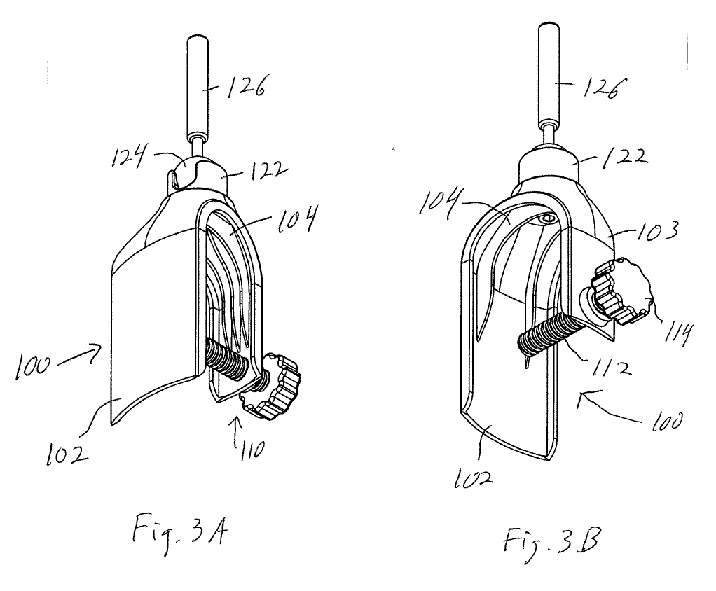

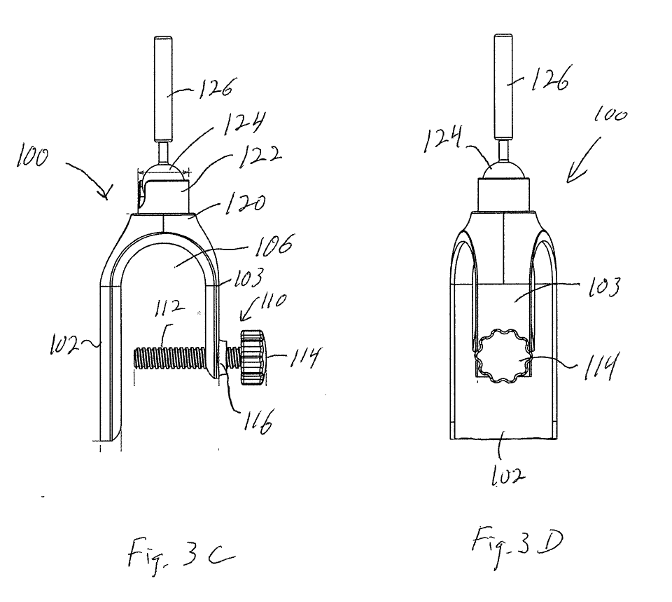

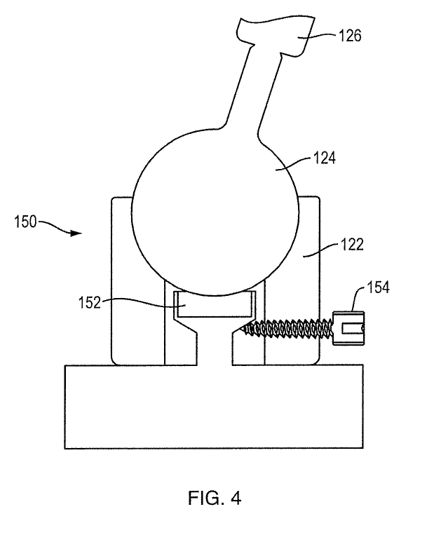

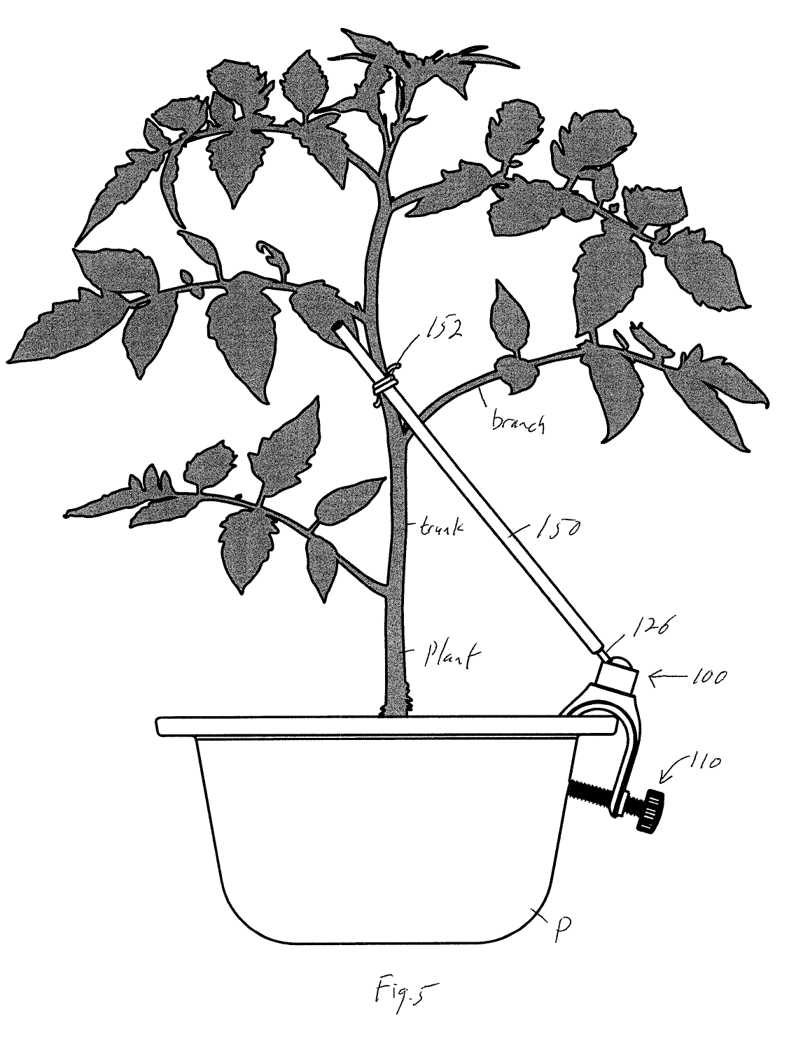

Another plant training system includes base 100, shown in FIGS. 3A-3D and FIG. 4. Base 100 includes saddle 102 that can be reinforced with internal ribbing 104. The saddle can sit over the top rim of a pot, and can be held in place on the pot using thumbscrews 110 with knob 114 and screw portion 112 that is received in threaded receiver 116. Top portion 120 carries socket portion 122 that receives ball 124 that comprises the lower end of stake 126. Stake 126 can have a desired length, and can have a mechanical configuration that allows a longer stake or pole to be coupled to it in order to allow the user to accomplish a desired height of the stake. In this non-limiting example, the upper end of stake 126 is a threaded stud or a threaded female receptacle. Then, extension poles (desirably but not necessarily of different lengths (not shown)) that are threaded at one end in a complementary manner so as to be able to be coupled to the end of stake 126, can be used to accomplish the desired height. Ball 124 is carried by socket 122 in a manner that allows the ball to be freely moved in the socket, such that the stake is adjustable through 360 degrees. This construction allows the stake height and its angular positions along the side of the pot and in and out relative to the pot, to be varied, to accommodate different plants, and plants of different height, diameter, and branch structure.

One non-limiting example of an adjustable ball-and-socket type joint for the base/stake, is shown in FIG. 4. Joint 150 comprises ball 124 that sits in socket 122. Cup 152 contacts the bottom of ball 124. Screw 154 is able to push against the angled bottom of cup 152, which varies the pressure applied to the ball by the cup. This varies the force by which the ball is pushed against the socket, which varies the friction that can prevent the ball from moving. The screw can be released to allow the stake to be re-positioned, and then tightened to hold the stake in place. There are alternative mechanisms that can be used to hold the ball in place in the socket, as would be apparent to one skilled in the mechanical field. As one non-limiting example, the screw could have a rubber tip that directly contacted the ball so as to push the ball against the socket and thus hold the ball in place.

The system can be used as follows. Two or more bases are spaced around the pot and held to its outside with a mechanical system that removably holds the bases on the outside of the pot. Stakes or poles of desired length are coupled to the bases. The angle of the stakes can be adjusted in or out and left and right as desired. Devices such as twine, nets or other structures are then coupled to the stakes and to the branches of the plant, to support the branches and train the branches to grow in desired directions. The supports (stakes and twine) can then be adjusted as needed as the plant grows.

FIG. 5 shows base 100 with stake 126, coupled to pot P in which a plant with a trunk and a branch is located. Extension pole 150 is coupled to stake 126. Tie or twine 152 is wrapped around pole 150 and also wrapped around the trunk, and thus ties the plant to the pole. Tie 152 helps hold the plant in a desired location. Note that poles and ties can also be used with branches or any other parts of plants.

A number of implementations have been described. Nevertheless, it will be understood that additional modifications may be made without departing from the scope of the inventive concepts described herein, and, accordingly, other embodiments are within the scope of the following claims.

What is claimed is:

1. A plant training system for use with a pot that is arranged to hold a plant, comprising:
a plurality of bases that are adapted to be coupled to the pot, wherein each base is adapted to carry a stake or pole, and wherein the angle of the stake or pole relative to the pot is adjustable; and
a mechanical system for holding each base on the pot.

2. The plant training system of claim 1 wherein the stakes are of different lengths.

3. The plant training system of claim 1, wherein the length of the stakes can be adjusted with a stake system in which multiple stakes nest one within another.

4. The plant training system of claim 1, wherein the bases comprise a plate that supports a stand that has a number of legs that sit against the outside of the pot.

5. The plant training system of claim 1, wherein each base comprises a socket that carries a stake, where the sockets are angularly adjustable.

6. The plant training system of claim 5, wherein the stakes comprise a ball that is fitted into a socket.

7. The plant training system of claim 6, wherein each base further comprises a mechanism for holding the ball in place in the socket.

8. The plant training system of claim 7, wherein the mechanism for holding the ball in place in the socket comprises a screw.

9. The plant training system of claim 8, wherein the mechanism for holding the ball in place in the socket further comprises a cup that contacts the ball, wherein the screw is adapted to move the cup relative to the ball.

10. The plant training system of claim 8, wherein the screw contacts the ball.

11. The plant training system of claim 1, wherein each base comprises a pulley and the mechanical system for holding the bases on the pot comprises a cord or cable that runs circumferentially around the pot and is coupled to each base via the pulleys.

12. The plant training system of claim 11, wherein the cord or cable can be tightened in order to hold the bases on the pot.

13. The plant training system of claim 12, wherein the cord or cable can be tightened using a ratchet-type cable tightening system or a cam jam type cord tightening device.

14. The plant training system of claim 1, further comprising twine that is constructed such that it can be used to couple part of a plant to a stake.

15. The plant training system of claim 14, wherein the twine comprises a pliable metal core with an overcoat of anti-microbial polymer.

16. The plant training system of claim 15, wherein the polymer comprises a UV-stabilized thermoplastic rubber.

17. The plant training system of claim 1, wherein each base comprises a projecting stud that is adapted to be coupled to a stake that has a threaded opening.

18. A plant training system for use with a pot that is arranged to hold a plant, comprising:
a plurality of bases that are adapted to be coupled to the pot, wherein each base is adapted to carry a stake or pole, and wherein an angle of the stake or pole relative to the pot is adjustable, wherein each base comprises a socket that carries a stake, where the sockets are angularly adjustable, wherein the stakes comprise a ball that is fitted into a socket and a projecting stud that is adapted to be coupled to a stake that has a threaded opening, and wherein each base further comprises a cup that contacts the ball and a screw that is adapted to move the cup relative to the ball to hold the ball in place in the socket; and
a mechanical system for holding each base on the pot.

19. The plant training system of claim 18, comprising a plurality of stakes of different lengths.

20. The plant training system of claim 19, further comprising twine that is constructed such that it can be used to couple part of a plant to a stake, wherein the twine comprises a pliable metal core with an overcoat of anti-microbial UV-stabilized thermoplastic rubber.
